(19) United States
(12) Patent Application Publication
(10) Pub. No.: US 2025/0094864 A1
(43) Pub. Date: Mar. 20, 2025

(54) COMPRESSION OF MACHINE LEARNING MODELS VIA SPARSIFICATION AND QUANTIZATION

(71) Applicant: NVIDIA Corporation, Santa Clara, CA (US)

(72) Inventors: Po-An Tsai, Somerville, MA (US); Geonhwa Jeong, Atlanta, GA (US); Jeffrey Michael Pool, Chapel Hill, NC (US)

(21) Appl. No.: 18/602,951

(22) Filed: Mar. 12, 2024

Related U.S. Application Data
(60) Provisional application No. 63/538,465, filed on Sep. 14, 2023.

(51) Int. Cl. G06N 20/00

(52) U.S. Cl. CPC G06N 20/00

(57) ABSTRACT

Machine learning is a process that learns a model from a given dataset, where the model can then be used to make a prediction about new data. In order to reduce the size, computation, and latency of a machine learning model, a compression technique can be employed which includes model sparsification and quantization. To limit the extent to which the quality of the model is impacted when uniformly applying sparsification and quantization to all values of the model, the present disclosure provides for a hybrid sparsification and quantization of the model.

### RELATED APPLICATION(S)

This application claims the benefit of U.S. Provisional Application No. 63/538,465 (Attorney Docket No. NVIDP1382+/23-WE-0709US01), titled “ACCELERATION OF LARGE LANGUAGE MODEL INFERENCE WITH MIXED PRECISION AND STRUCTURED SPARSITY” and filed Sep. 14, 2023, the entire contents of which is incorporated herein by reference.

### TECHNICAL FIELD

The present disclosure relates to compression and/or acceleration of machine learning models.

### BACKGROUND

Machine learning is an artificial intelligence technique that involves a computer process learning a model from a given dataset, where the model can then be used to make a prediction about new data. Thus, machine learning allows for the model to be learned from data, instead of being defined as a preconfigured equation. Typically, the machine learning model includes a large number of interconnected processing (i.e. computational) units which are arranged in layers.

As machine learning techniques have made progress towards improving model performance (e.g. accuracy), the costs associated with these improved models has increased, such as the model size, computation requirements, and latency. Besides generally consuming a greater amount of computer resources to run these models, the increased costs can completely hinder deployment to applications that suffer from limited resources.

In order to address these issues, techniques have been developed to compress machine learning models. Often, compression involves some sparsification of the model, including pruning (i.e. removing) redundant or insignificant parts (e.g. weights, connections, etc.) of the model for more efficient storage and computation. Other compression methods can rely on quantization, or more specifically reducing a bit width of at least a portion of the weights of the model.

While existing model compression techniques can provide practical speedup of model execution and reduced memory consumption for model storage, they are susceptible to significantly impacting model quality. In particular, existing techniques typically treat inlier and outlier model weights the same, for example by uniformly applying sparsification and/or quantization methods to all weights of the model. However, compression involving the outlier values will have a greater negative impact on the model than compression involving the inlier values, and this is especially true with regards to quantization.

There is thus a need for addressing these issues and/or other issues associated with the prior art. For example, there is a need to compress and/or accelerate machine learning models via sparsification and quantization that is not uniformly applied to all values of the model.

### SUMMARY

A method, computer readable medium, and system are disclosed for processing a machine learning model. The model is processed by apportioning a plurality of different subsets of values of the machine learning model into a plurality of data structures each having a defined structured sparse pattern. The model is further processed by changing a data representation of at least one data structure of the plurality of data structures, wherein at least two data structures of the plurality of data structures have different data representations.

### BRIEF DESCRIPTION OF THE DRAWINGS

FIG. 1 illustrates a flowchart of a method for processing a machine learning model, in accordance with an embodiment.

FIG. 2 illustrates a flowchart of a method for processing a machine learning model, in accordance with an embodiment.

FIG. 3 illustrates a visual depiction of the machine learning model values during the method of FIG. 2, in accordance with an embodiment.

FIG. 4 illustrates a block diagram of a multi-processor system for using the machine learning model resulting from the method of FIG. 1, in accordance with an embodiment.

FIG. 5 illustrates a block diagram of a single processor system for using the machine learning model resulting from the method of FIG. 1, in accordance with an embodiment.

FIG. 6 illustrates a flowchart of a method for using the machine learning model resulting from the method of FIG. 1 in a downstream task, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

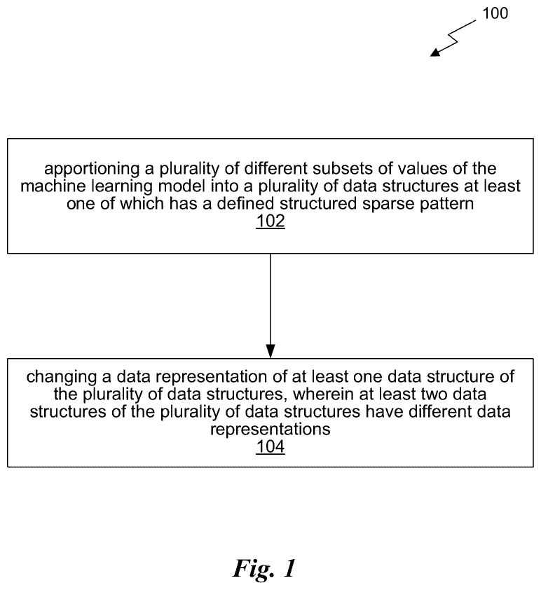

FIG. 1 illustrates a flowchart of a method 100 for processing a machine learning model, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

As mentioned, the method 100 operates to process a machine learning model. A result of the method 100 is a compressed and/or accelerated machine learning model. The machine learning model refers to a model, or program, that is trained via machine learning to make an inference from an input (where the input may include data previously unseen by the model). In an embodiment, the machine learning model is a deep neural network. In another embodiment, the machine learning model is a large language model (LLM). Processing of the machine learning model refers to reducing a storage requirement (compression) and/or computing requirement (acceleration via reduced computation) of the machine learning model.

The machine learning model includes values, in particular that are capable of being apportioned into data structures in accordance with some defined criteria (see description of operation 102 below). The values refer to any parameters of the machine learning model. The parameters affect the computations performed by the machine learning model.

In an embodiment, the values may be weights of the machine learning model. A machine learning model weight generally defines an amount by which a data or intermediate activation value is weighted during a computation by the model, and in an embodiment can determine the influence that an input data has on an output product. The weights may be defined for a plurality of layers, neurons, etc. of the machine learning model.

Optionally, prior to operations 102-104 described below, the method for processing of the machine learning model may include sparsifying the machine learning model by pruning values from the machine learning model, to form a sparse machine learning model. Pruning a value refers to removing the value or replacing the value with a zero or null or some other predefined value. In an embodiment, the values of the machine learning model are selected for pruning according to a defined threshold metric (e.g. a magnitude of weight, an error after pruning, a product of a corresponding weight and activation obtained with training or validation data, etc.). The remaining values may be adjusted to compensate for the error. In an embodiment, the machine learning model may be sparsified, or made more sparse, to a defined degree of sparsity. The degree of sparsity may be defined by a percentage of non-zero values pruned from the machine learning model. In an embodiment, the machine learning model may be sparsified with a defined structured sparse pattern (i.e. having a defined pattern of sparseness).

Returning to operation 102, a plurality of different subsets of values of a machine learning model are apportioned into a plurality of data structures at least one of which has a defined structured sparse pattern. In an embodiment, the plurality of different subsets of values of the machine learning model may be determined from the sparse machine learning model described above. In another embodiment where the machine learning model has not already been sparsified, the plurality of different subsets of values of the machine learning model may be determined from the original machine learning model.

As mentioned, a plurality of different subsets of the values of the machine learning model are apportioned into a plurality of data structures (e.g. tensors), where one or more of the data structures has a defined structured sparse pattern. In other words, one subset of the values is stored in one data structure (e.g. with a defined structured sparse pattern), another subset of the values is stored in another data structure (e.g. with a defined structured sparse pattern), etc. The structured sparse patterns may be the same or different with respect to two or more of the data structures.

A sparse pattern refers to a pattern, and/or degree, of sparsity. In an embodiment, the sparse pattern of a data structure may define how many zero values are stored in the data structure and/or the pattern by which the zeros are stored in the data structure. Just by way of example, a first defined structured sparse pattern (e.g. of at least one of the data structures) may have a first sparsity and a second defined structured sparse pattern (e.g. of at least another one of the data structures) may have a second sparsity, where the first sparsity is different from the second sparsity.

The values of the machine learning model may be grouped into subsets in accordance with a defined criteria. In an embodiment, each subset may be limited to a defined number of the values of the machine learning model. In an embodiment, inlier and outlier values may be grouped in different subsets. For example, the plurality of different subsets of values of the machine learning model may include at least one subset comprised of at least a portion of inlier values of the machine learning model and at least another subset comprised of at least a portion of outlier values of the machine learning model. In an embodiment, the inlier values and the outlier values may be determined according to a defined threshold metric (e.g. a magnitude of weight, an error after quantization for inlier and outlier. a product of a corresponding weight and activation, etc.). In an embodiment, at least a portion of the inlier values may be stored with a first structured sparse pattern that has less sparsity than a second structured sparse pattern used to store at least a portion of the outlier values.

In operation 104, a data representation of at least one data structure of the plurality of data structures is changed, wherein at least two data structures of the plurality of data structures have different data representations. In an embodiment, the changing of the data representation of a data structure may include quantizing the data structure. The data representation of a data structure refers to a format of the data structure, such as a data type, bit width, etc. of the data structure.

In an embodiment, the plurality of data structures into which the subset of values are apportioned may all have a same data representation. Then, operation 104 may be performed to change the data representation of at least one of the data structures. For example, in an embodiment a data type of at least one of the data structures may be changed from a first data type to a second data type. As another example, in an embodiment a bit width of at least one of the data structures may be changed from a first bit width to a second bit width.

Each data structure for which the data representation is to be changed may be selected based on a defined criteria. For example, one or more data structures storing values meeting the criteria may have their data representation changed, without necessarily changing the data representations of data structures storing other values of the machine learning model not meeting the criteria. As another example, all of the data structures may have their data representations changed, so long as at least two data structures of the plurality of data structures have resulting different data representations.

In an embodiment, one or more data structures storing inlier values of the machine learning model may have their data representation changed, without necessarily changing the data representations of data structures storing outlier values of the machine learning model. In this embodiment, a first bit width of these data structures storing inlier values may be changed to a second, lower bit width. As a result, data structures storing the inlier values may have a lower bit width than data structures storing outlier values. As another option for this embodiment, a first data type of these data structures storing inlier values may be changed to a second, generalized data type. As a result, data structures storing the inlier values may have a more general data type than data structures storing outlier values.

In an embodiment, the different data representations may be supported by a single hardware accelerator. In other words, a same hardware accelerator may be usable to perform computations involving the different data representations. In another embodiment, the different data representations may be supported by multiple different hardware accelerators. For example, one hardware accelerator may support one of the data representations while another hardware accelerator may support another one of the data representations. While the descriptions above may refer to two different data representations, it should be noted that operation 104 may similarly be performed to result in data structures having three or even more different data representations, some or all of which may be supported by the same or different hardware accelerators.

In yet another embodiment, different hardware accelerators may also support different structured sparse patterns. Thus, when two or more of the data structures having different defined structured sparse patterns, these data structures may be handled by the respective hardware accelerators configured to support them. In the present description, a hardware accelerator refers to specialized computer hardware configured to perform computations for the machine learning model, where the hardware accelerator may be specifically configured to handle one or more particular data types.

By changing the data representation of one or more of the data structures storing values of the machine learning model, a storage requirement and/or computation requirement of those data structures may be reduced, thereby resulting in a compressed and/or accelerated machine learning model. For example, reducing the bit width, or generalizing the data type, of one or more of the data structures may reduce a storage requirement and/or computation requirement for those data structures and in turn the storage requirement and/or computation requirement of the machine learning model. Furthermore, by selectively changing the data representation of only some data structures, the data representation changes may not be uniformly applied to all values of the model. This allows for values having a more significant impact on quality of the machine learning model, such as outlier values, to be stored with a greater precision than values having a more significant impact on the quality of the machine learning model, such as inlier values. As a result, a quality of the compressed machine learning model may be improved when compared to a machine learning model whose values have been uniformly sparsified and/or quantized.

In one exemplary implementation of the method 100 for processing a machine learning model, the machine learning model is initially processed to generate a plurality of sparse data structures by storing inlier values of the machine learning model in a first data structure, and storing outlier values of the machine learning model in a second data structure, where at least one of the first data structure or the second data structure has a structured sparse pattern. In an embodiment of this exemplary implementation, the inlier values and the outlier values may be weights of the machine learning model, for example which have been determined according to a defined threshold metric. In an embodiment of this exemplary implementation, a first structured sparse pattern of the first data structure may have less or the same sparsity than a second structured sparse pattern of the second data structure. The sparse machine learning model is then non-uniformly quantized by quantizing the first data structure storing the inlier values to a first bit width, and quantizing the second data structure storing the outlier values to a second bit width that is different from the first bit width. In an embodiment of this exemplary implementation, the first bit width and the second bit width may be supported by different hardware accelerators.

Further embodiments will now be provided in the description of the subsequent figures. It should be noted that the embodiments disclosed herein with reference to the method 100 of FIG. 1 may apply to and/or be used in combination with any of the embodiments of the remaining figures below.

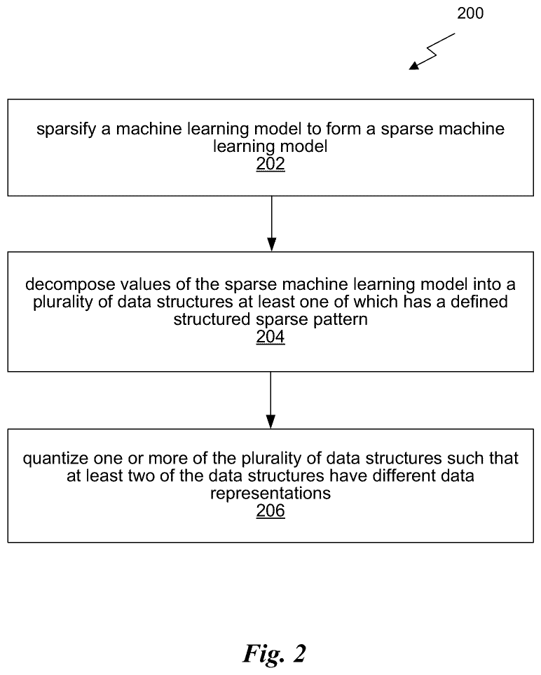

FIG. 2 illustrates a flowchart of a method 200 for processing a machine learning model, in accordance with an embodiment. The method 200 may be performed in accordance with the method 100 of FIG. 1. Of course, however, the method 200 may be performed in the context of any of the other embodiments described herein. The definitions and embodiments described above may equally apply to the description of the present embodiment.

In operation 202, a machine learning model is sparsified to form a sparse machine learning model. In an embodiment, the machine learning model may be uniformly sparsified according to a defined threshold metric. For example, values of the machine learning model may be selected for pruning according to the defined threshold metric, which may be a magnitude of weight, an error after pruning, a product of a corresponding weight and activation obtained with training or validation data, etc. In an embodiment, the machine learning model may be sparsified, or made more sparse, to a defined degree of sparsity. In another embodiment, the machine learning model may be sparsified with a defined structured sparse pattern (e.g. [1˜8]:8 or [1˜4]:4 or etc.).

In operation 204, values of the sparse machine learning model are decomposed into a plurality of data structures at least one of which has a defined sparse structured pattern. This may be performed in accordance with operation 102 of FIG. 1. In an embodiment, the decomposition may be an additional, but not necessarily uniform, sparsification of the machine learning model.

For example, the defined sparse structured pattern of at least one of the data structures may be different from the defined structured sparse pattern by which the machine learning model is sparsified in operation 202. In another embodiment, the defined sparse structured pattern of at least one of the data structures may have greater sparsity than the defined structured sparse pattern by which the machine learning model is sparsified in operation 202. In one exemplary embodiment, a structured sparse pattern of [1-4]:8 for outliers and remaining for inliers may be used, or [1-2]:4 for outliers and remaining for inliers, or etc.

In operation 206, one or more of the plurality of data structures are quantized such that at least two of the data structures have different data representations. This may be performed in accordance with operation 104 of FIG. 1. Thus, the quantization may be non-uniformly applied to the machine learning model.

The result of the method 200 may be two or more data structures storing values of the machine learning model, with at least two of the data structures having different data representations. For example, FP16 may be used for outliers and FP4 for inliers with vector scaled quantization (VSQ), or INT8 may be used for outliers and FP4 for inliers with VSQ. Furthermore, at least two of the data structures may also have different defined structured sparse patterns.

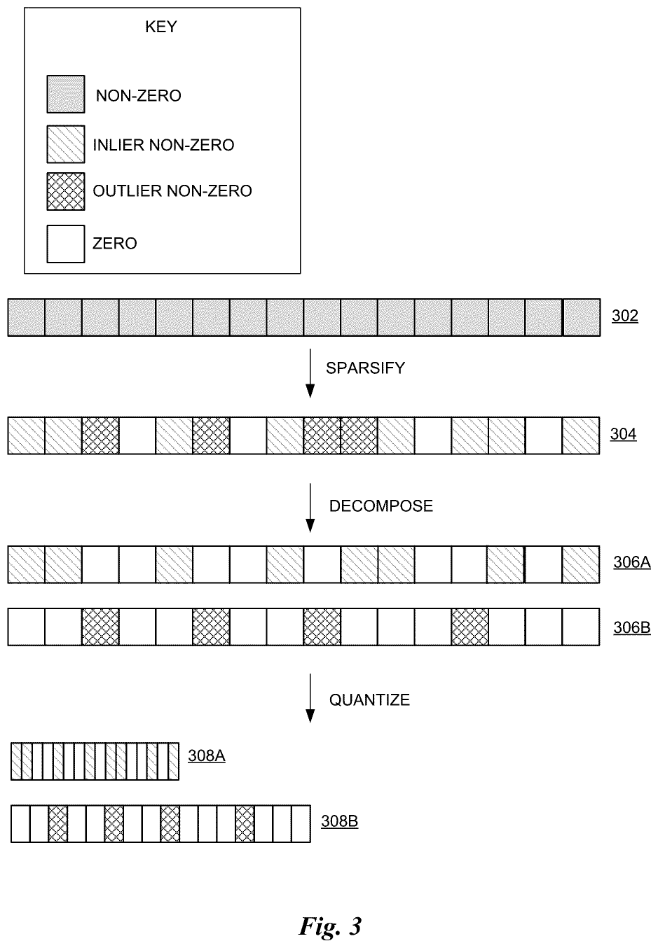

FIG. 3 illustrates a visual depiction of the machine learning model values during the processing method of FIG. 2, in accordance with an embodiment.

As shown, prior to the processing, the machine learning model includes a plurality of non-zero values. The plurality of non-zero values are represented in a first data structure 302 (e.g. tensor). In the present embodiment, a non-zero value refers to a value (e.g. weight) that has been defined and/or optimized during training of the machine learning model.

The machine learning model is then sparsified to form a sparsified machine learning model (e.g. operation 202 of FIG. 2). In particular, the sparsification prunes values from the machine learning model. The sparsified values are represented in a second data structure 304 having a defined structured sparse pattern. The sparsified values include both inlier and outlier values.

The values in the second data structure 304 are then decomposed into a plurality of data structures each having a defined structured sparse pattern (e.g. operation 204 of FIG. 2). In the present example, only two data structures are shown, one data structure 306A storing the inlier values in a first defined structured sparse pattern and the other data structure 306B storing the outlier values in a second defined structured sparse pattern. The first defined structured sparse pattern is less sparse than the second defined structured sparse pattern.

The values in at least one of the data structures 306A, 306B are then quantized to result in the data structures 308A, 308B having different data representations. In the present example shown, while both data structures 306A, 306B are quantized, the data structure 306A storing the inlier values in the first defined structured sparse pattern is quantized to a lower bit width (see resulting quantized data structure 308A) than the bit width used for the data structure 306B storing the outlier values in the second defined structured sparse pattern (see resulting quantized data structure 308B). To this end, one compressed data structure 308A stores inlier values of the machine learning model with less sparsity and lesser bit width than the other compressed data structure 308B that stores outlier values of the machine learning model.

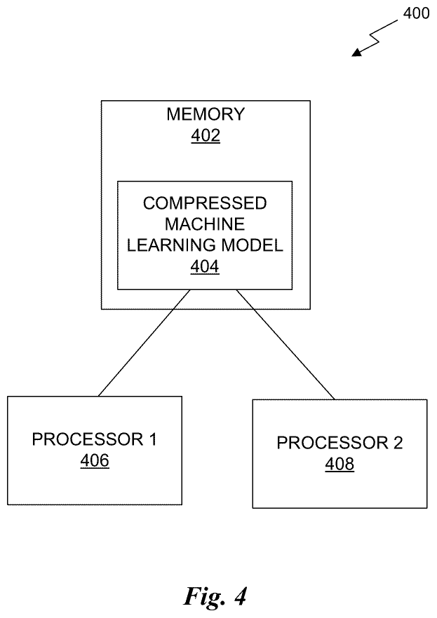

FIG. 4 illustrates a block diagram of a multi-processor system 400 for using the machine learning model resulting from the method 100 of FIG. 1, in accordance with an embodiment.

As shown, the system 400 includes a memory (non-transitory) 402 that stores the machine learning model 404 resulting from the method 100 of FIG. 1. The machine learning model 404 is represented, in part, by at least one first data structure storing values of the model using a first data representation and at least one second data structure storing values of the model using a second data representation.

The first data representation is supported by a first processor 406 and the second data representation is supported by a second processor 408. During run-time, computations involving the values stored using the first data representation are performed by the first processor 406 and computations involving the values stored using the second data representation are performed by the second processor 408.

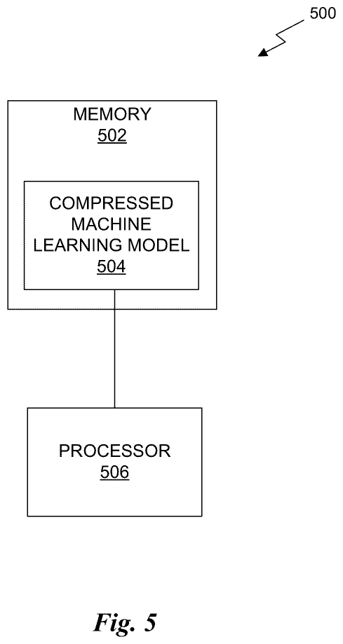

FIG. 5 illustrates a block diagram of a single processor system 500 for using the machine learning model resulting from the method 100 of FIG. 1, in accordance with an embodiment.

As shown, the system 500 includes a memory (non-transitory) 502 that stores the machine learning model 504 resulting from the method 100 of FIG. 1. The machine learning model 504 is represented, in part, by at least one first data structure storing values of the model using a first data representation and at least one second data structure storing values of the model using a second data representation.

Both the first data representation and the second data representations are supported by a same processor 506. During run-time, computations involving the values stored using the first data representation are performed by the same processor 506 as computations involving the values stored using the second data representation.

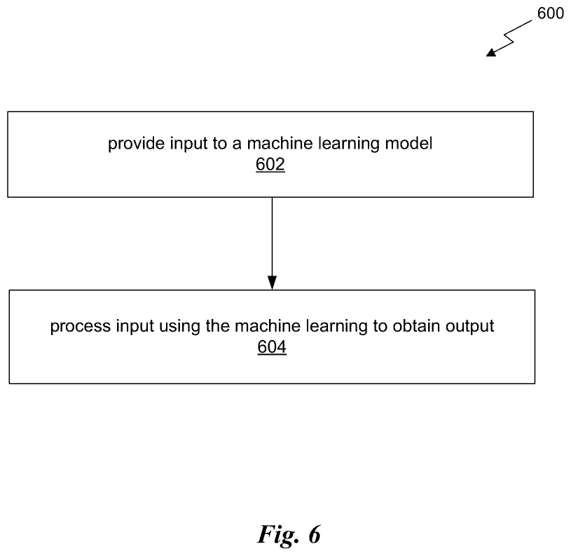

FIG. 6 illustrates a flowchart of a method 600 for using the machine learning model resulting from the method 100 of FIG. 1 in a downstream task, in accordance with an embodiment. Of course, the method 600 may be performed using the machine learning model processed in accordance with any of the methods and/or systems described above. The definitions and embodiments described above may equally apply to the description of the present embodiment.

In operation 602, input is provided to a machine learning model. The input may be any data intended for processing by the machine learning model. In an embodiment, the input may be in a format which the machine learning model is configured to be able to process.

In operation 604, the input is processed by the machine learning model to obtain output. The input may be processed using the values of the machine learning model and other features of the machine learning model such as the channels, layers, etc. In an embodiment, the machine learning model is a compressed model and/or accelerated model trained to make a certain type of prediction given an input. Thus, the output is a prediction or inference made by the machine learning model based upon the input.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

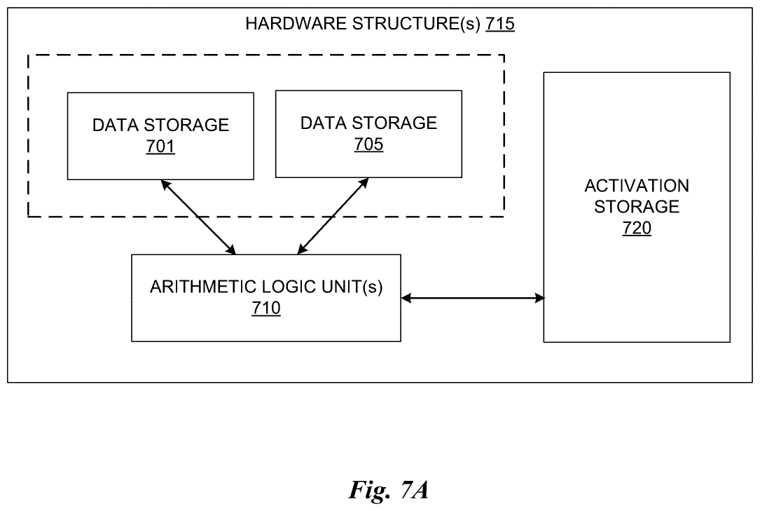

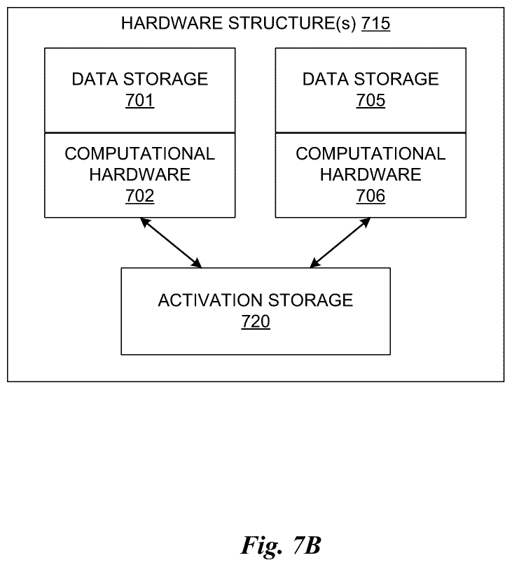

As noted above, a deep learning or neural learning system needs to be trained to generate inferences from input data. Details regarding inference and/or training logic 715 for a deep learning or neural learning system are provided below in conjunction with Figures. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™M, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

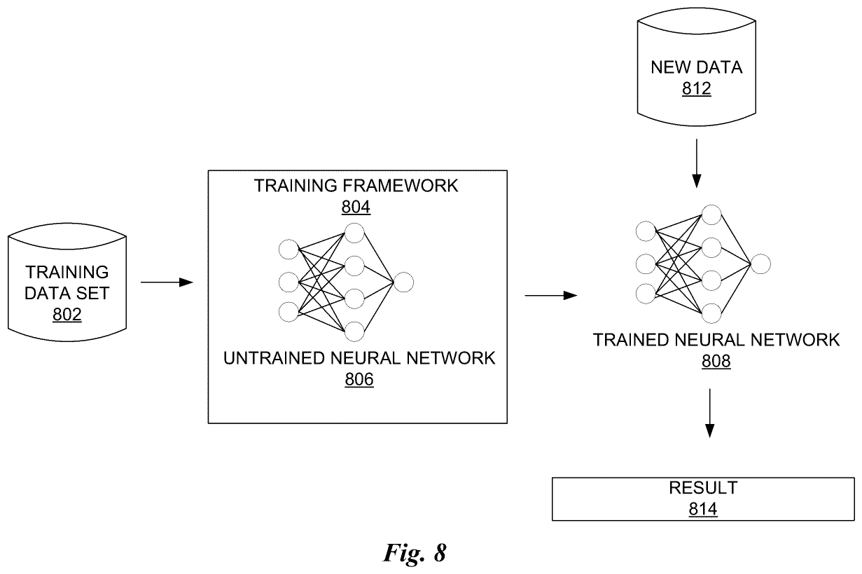

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

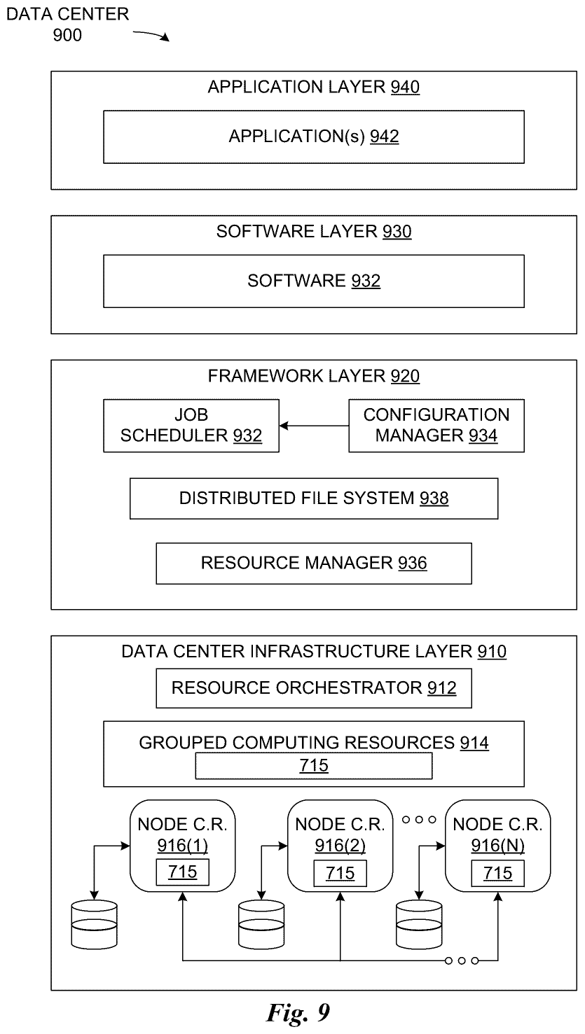

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for machine learning model compression. In accordance with FIGS. 1-6, embodiments may provide and use a compressed machine learning model. The compressed machine learning model may be stored (partially or wholly) in one or both of data storage 701 and 705 in inference and/or training logic 715 as depicted in FIGS. 7A and 7B. Training and deployment of the machine learning model may be performed as depicted in FIG. 8 and described herein. Distribution of the machine learning model may be performed using one or more servers in a data center 900 as depicted in FIG. 9 and described herein.

What is claimed is:

1. A method, comprising:
at a device, compressing a machine learning model having a plurality of values to reduce at least one of a size of the machine learning model or computation requirements of the machine learning model, by:
processing the machine learning model to generate a plurality of sparse data structures including:
storing inlier values of the machine learning model in a first data structure, and
storing outlier values of the machine learning model in a second data structure,
wherein at least one of the first data structure or the second data structure has a structured sparse pattern; and
non-uniformly quantizing the machine learning model, including:
quantizing the first data structure storing the inlier values to a first bit width, and
quantizing the second data structure storing the outlier values to a second bit width that is different from the first bit width.

2. The method of claim 1, wherein the inlier values and the outlier values are weights of the machine learning model.

3. The method of claim 1, wherein the inlier values and the outlier values are determined according to a defined threshold metric.

4. The method of claim 1, wherein the first data structure has a first structured sparse pattern that has less sparsity than a second structured sparse pattern of the second data structure.

5. The method of claim 1, wherein the first data structure has a first structured sparse pattern that is the same as a second structured sparse pattern of the second data structure.

6. The method of claim 1, wherein the first bit width and the second bit width are supported by different hardware accelerators.

7. A method, comprising:
at a device:
apportioning a plurality of different subsets of values of the machine learning model into a plurality of data structures at least one of which has a defined structured sparse pattern; and
changing a data representation of at least one data structure of the plurality of data structures, wherein at least two data structures of the plurality of data structures have different data representations.

8. The method of claim 7, wherein the machine learning model is a deep neural network.

9. The method of claim 7, wherein the machine learning model is a large language model (LLM).

10. The method of claim 7, wherein the values of the machine learning model are weights of the machine learning model.

11. The method of claim 7, wherein the plurality of data structures are tensors.

12. The method of claim 7, wherein at least two of the plurality of data structures have different defined structured sparse patterns.

13. The method of claim 12, wherein the different defined structured sparse patterns include at least:
a first defined structured sparse pattern having a first sparsity degree, and
a second defined structured sparse pattern having a second sparsity degree,
wherein the first sparsity degree is different from the second sparsity degree.

14. The method of claim 7, wherein the plurality of different subsets of values of the machine learning model include:
at least one subset comprised of at least a portion of inlier values of the machine learning model, and
at least another subset comprised of at least a portion of outlier values of the machine learning model.

15. The method of claim 14, wherein the inlier values and the outlier values are determined according to a defined threshold metric.

16. The method of claim 15, wherein the defined threshold metric is a magnitude of weight.

17. The method of claim 15, wherein the defined threshold metric is an error after quantization for inlier and outlier.

18. The method of claim 15, wherein the defined threshold metric is a product of a corresponding weight and activation.

19. The method of claim 14, wherein at least a portion of the inlier values are stored with a first structured sparse pattern that has less sparsity than a second structured sparse pattern used to store at least a portion of the outlier values.

20. The method of claim 7, wherein the machine learning model is further compressed by:
sparsifying the machine learning model by pruning values from the machine learning model, to form a sparse machine learning model,
wherein the plurality of different subsets of values of the machine learning model are determined from the sparse machine learning model.

21. The method of claim 20, wherein the values of the machine learning model are selected for pruning according to a defined threshold metric.

22. The method of claim 21, wherein the defined threshold metric is a magnitude of weight.

23. The method of claim 21, wherein the defined threshold metric is an error after pruning.

24. The method of claim 21, wherein the defined threshold metric is a product of a corresponding weight and activation obtained with training or validation data.

25. The method of claim 20, wherein the machine learning model is sparsified to a defined degree of sparsity.

26. The method of claim 20, wherein the machine learning model is sparsified with a defined structured sparse pattern.

27. The method of claim 7, wherein changing the data representation of the at least one data structure includes quantizing the at least one data structure.

28. The method of claim 7, wherein the data representation of the plurality of data structures includes a bit width of the plurality of data structures.

29. The method of claim 7, wherein the data representation of the plurality of data structures includes a data type of the plurality of data structures.

30. The method of claim 7, wherein the different data representations are supported by a single hardware accelerator or multiple different hardware accelerators.

31. The method of claim 7, wherein at least two of the plurality of data structures have different defined structured sparse patterns, and wherein the different defined structured sparse patterns are supported by a single hardware accelerator or multiple different hardware accelerators.

32. A system, comprising:
a non-transitory memory storage comprising instructions; and
one or more processors in communication with the memory, wherein the one or more processors execute the instructions to at least one of compress a machine learning model or reduce a computation of the machine learning model by:
apportioning a plurality of different subsets of values of the machine learning model into a plurality of data structures at least one of which has a defined structured sparse pattern; and
changing a data representation of at least one data structure of the plurality of data structures, wherein at least two data structures of the plurality of data structures have different data representations.

33. The system of claim 32, wherein the machine learning model is a deep neural network.

34. The system of claim 32, wherein the machine learning model is a large language model (LLM).

35. The system of claim 32, wherein the values of the machine learning model are weights of the machine learning model.

36. The system of claim 32, wherein at least two of the plurality of data structures have different defined structured sparse patterns.

37. The system of claim 32, wherein the plurality of different subsets of values of the machine learning model include:
at least one subset comprised of at least a portion of inlier values of the machine learning model, and
at least another subset comprised of at least a portion of outlier values of the machine learning model.

38. The system of claim 37, wherein at least a portion of the inlier values are stored with a first structured sparse pattern that has less sparsity than a second structured sparse pattern used to store at least a portion of the outlier values.

39. The system of claim 32, wherein changing the data representation of the at least one data structure includes quantizing the at least one data structure.

40. The system of claim 32, wherein the data representation of the plurality of data structures includes a bit width of the plurality of data structures.

41. The system of claim 32, wherein the data representation of the plurality of data structures includes a data type of the plurality of data structures.

42. A non-transitory computer-readable media storing computer instructions which when executed by one or more processors of a device cause the device to at least one of compress a machine learning model or reduce a computation of the machine learning model by:
apportioning a plurality of different subsets of values of the machine learning model into a plurality of data structures at least one of which has a defined structured sparse pattern; and
changing a data representation of at least one data structure of the plurality of data structures, wherein at least two data structures of the plurality of data structures have different data representations.

43. The non-transitory computer-readable media of claim 42, wherein the machine learning model is a deep neural network.

44. The non-transitory computer-readable media of claim 42, wherein the machine learning model is a large language model (LLM).

45. The non-transitory computer-readable media of claim 42, wherein the values of the machine learning model are weights of the machine learning model.

46. The non-transitory computer-readable media of claim 42, wherein at least two of the plurality of data structures have different defined structured sparse patterns.

47. The non-transitory computer-readable media of claim 42, wherein the plurality of different subsets of values of the machine learning model include:
at least one subset comprised of at least a portion of inlier values of the machine learning model, and
at least another subset comprised of at least a portion of outlier values of the machine learning model.

48. The non-transitory computer-readable media of claim 47, wherein at least a portion of the inlier values are stored with a first structured sparse pattern that has less sparsity than a second structured sparse pattern used to store at least a portion of the outlier values.

49. The non-transitory computer-readable media of claim 42, wherein changing the data representation of the at least one data structure includes quantizing the at least one data structure.

50. The non-transitory computer-readable media of claim 42, wherein the data representation of the plurality of data structures includes a bit width of the plurality of data structures.

51. The non-transitory computer-readable media of claim 42, wherein the data representation of the plurality of data structures includes a data type of the plurality of data structures.
